(19) United States
(12) Patent Application Publication
(10) Pub. No.: US 2005/0281297 A1
(43) Pub. Date: Dec. 22, 2005

(54) Vertical cavity surface emitting laser, telecommunication system and corresponding method

(75) Inventors: Vivien M. Verbrugge, Rennes (FR); Loig M. Plouzennec, La Haye (NL); Jean-Louis De Bougrenet De La Tocnaye, Guilers (FR)

Correspondence Address: MERCHANT & GOULD PC, P.O. BOX 2903, MINNEAPOLIS, MN, 55402-0903, US

(73) Assignee: OPTOGONE, Plouzane (FR)

(21) Appl. No.: 10/854,111

(22) Filed: May 25, 2004

(30) Foreign Application Priority Data
May 26, 2003 (FR) 03 06361

(51) Int. Cl. H01S 3/098

(52) U.S. Cl. 372/19; 372/50.1; 372/98

(57) ABSTRACT

This invention relates to a vertical cavity surface emitting laser (VCSEL) comprising at least one optical element inside the said cavity, the optical element having a variable optical loss profile (44) in a plane perpendicular to an axis of propagation of at least one light beam passing through the said cavity so as to encourage transverse mode of the said laser.

This invention relates to the domain of optical components, particularly for high-speed optical networks.

More precisely, the invention relates to vertical cavity lasers.

This description considers lasers that behave like laser sources when the energy input to the laser is greater than a laser excitation threshold specific to the component, and more particularly vertical cavity lasers.

In this context, Vertical Cavity Surface Emitting Lasers (VCSEL) have many advantages, particularly including good spectral selectivity and good modal adaptation with fibres due to the circular and only slightly divergent nature of the emitted beam.

A disadvantage of VCSELs according to the state of the art is that they emit a beam that is transverse multimode, which causes a reduction of the emitted power, a reduction in coupling of the power emitted in the single-mode fibres and the laser pass band and an increase in noise (reduction of the Side Mode Suppression Ratio (SMSR).

These disadvantages are described particularly in the document written by S. W. Z. Mahmoud, D. Wiedenmann, M. Kicherer, H. Unold, R. Jäger, R. Michalzik and K. J. Ebeling, entitled “Spatial investigation of transverse mode turn-on dynamics of VCSELs”) published in the IEEE Photonics Technology Letters review, Vol. 13, No. 11, 2001, pp. 1152-1154.

The French patent application deposited on Jun. 5, 2001 as number 0107333 by the GET/ENST Bretagne (Brittany) describes a VCSEL with a wide tuneability range. However, this VCSEL has the same disadvantages.

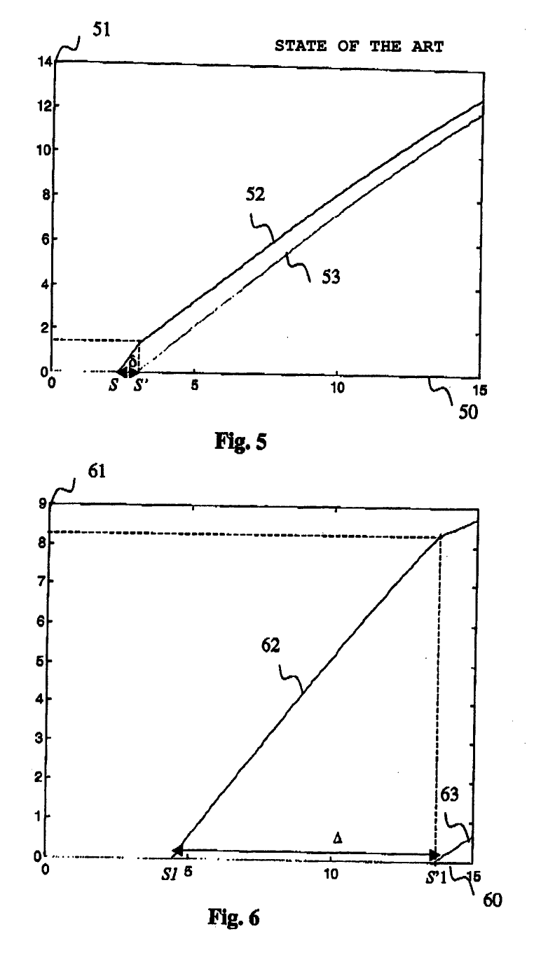

FIG. 5 illustrates the variation in the optical power 51 emitted by a VCSEL described in this patent application FR0107333 as a function of the bias intensity 50 (expressed in mA). A curve 52 more precisely illustrates the variation of power emitted in the fundamental transverse mode denoted LP01 while the curve 53 corresponds to the power emitted in a second mode called the first transverse mode denoted LP11. The threshold S of mode LP01 is located at about 2.3 mA while threshold S1 is close to 3 mA. Thus, the VCSEL is therefore single-mode for a bias intensity between 2.3 and 3 mA and multimode when it exceeds 3 mA. It can be seen that the difference δ between curves 52 and 53 is of the order of 0.7 mA which is relatively low. Thus, the bias range and the optical power during single-mode operation are very limited with this VCSEL.

Different techniques are proposed to force a VCSEL to operate in fundamental mode.

Thus, in the document written by L. J. Sargent, L. Plouzennec, R. V. Penty, I. H. White and P. J. Leard, entitled “Gaussian etched single transverse mode Vertical-Cavity Surface-Emitting Laser” and published at the CTuA42, CLEO 2000′ conference, pp. 166-167, a first layer of an upper Bragg mirror is selectively etched in order to reduce the modal reflectivity of transverse layers. Another possibility is described in the article entitled “Single-mode output power enhancement of InGaAs VCSELs by reduced spatial hole burning via surface etching”, written by H. J. Unold, M. Golling, F. Mederer, R. Michalzik, D. Supper and K. J. Ebeling and published in Electronics Letter, Vol. 37, No. 9, 2001, pp. 571-572. With this technique, the surface of the VCSEL is etched to modify guidance conditions of transverse modes. According to yet another technique (described in the article written by K. D. Choquette, A. J. Fischer, K. M. Geib, G. R. Hadley, A. A. Allerman and J. J. Hindi, entitled “High single-mode operation from hybrid Ion implanted/selectively oxidized VCSELs” and published in the IEEE conference report of the 17th Int. Semiconductor Laser Conf., Monterey, USA, September 2000, pp. 59-60), oxidation of a layer of gallium arsenide (AsGa) in the upper mirror causes a lens effect that facilitates guidance conditions for the fundamental mode. These techniques have the disadvantage that they are difficult to implement.

In particular, the purpose of the various aspects of this invention is to overcome these disadvantages according to prior art.

More precisely, one purpose of the invention is to provide VCSEL lasers that are relatively easy to manufacture while enabling single-mode operation within a wide range of bias currents.

Another purpose of the invention is to implement single-mode lasers enabling a relatively high emission power.

To achieve this purpose, the invention proposes a vertical cavity surface emitting laser (VCSEL) comprising at least one optical element inside the cavity, remarkable in that the optical element(s) has (have) a variable optical loss profile in a plane perpendicular to an axis of propagation of at least one light beam passing through the cavity so as to encourage transverse mode of the laser.

In this case, a transverse plane is defined as being a plane perpendicular to a propagation axis of at least one light beam passing through the cavity. Thus, the laser has a profile in a transverse plane that encourages the fundamental transverse mode to the detriment of other transverse modes. Thus, the difference between the emission threshold currents in fundamental mode and in other transverse modes (or between the bias currents necessary to enable the emission of a light beam in fundamental mode and in other transverse modes respectively) can be significantly increased. In other words, the laser remains transverse single-mode over a wide range of bias current.

According to one particular characteristic, the laser is remarkable in that the transverse mode is the fundamental transverse mode.

The laser thus obtained operating in fundamental transverse type single-mode (within a wide bias range) generates a thin cylindrical laser beam well adapted to many applications and particularly to:
telecommunication applications, for example to easily couple the laser with a small diameter optical fibre and/or to obtain higher modulation frequencies; and
optical disk reading applications.

According to one particular characteristic, the laser is remarkable in that the transverse mode is the first transverse mode.

Thus, a laser operating with a single-mode corresponding to the first transverse mode can be obtained. Thus, the laser operating in this mode emits a beam with a section in the form of a hollow disk, that is useful for some applications (for example in medicine, if treatment would require laser illumination in a zone surrounding a point that must not be touched).

According to one particular characteristic, the laser is remarkable in that at least two zones are distinguished in the plane, the loss profile being approximately constant in at least one of the zones and different in two distinct zones.

Thus, the loss profile may for example include two zones (the profile is then binary), or three or more zones.

In general, the binary profile widens the bias current range for single-mode operation of the laser and increases the resonant frequency of the laser while enabling relatively simple fabrication of the laser.

According to one particular characteristic, the laser is remarkable in that the radius of a central zone among the zones is between 1 and 5 μm.

In this case, the central zone corresponds to the zone closest to the laser axis. Thus, the bias current range for which operation in single-mode is possible is relatively wide, an optimum value being obtained for values close to 2 μm.

According to one particular characteristic, the laser is remarkable in that the loss profile varies approximately continuously in at least part of the plane.

In this way, the laser has a loss profile varying continuously:
in an entire transverse plane; or only
in part of a transverse plane, for example when it has different zones with a sudden variation of the loss profile when changing from one zone to the next, the profile inside each zone being constant or continuously variable.

According to one particular characteristic, the laser is remarkable in that the loss profile varies in an approximately Gaussian manner in at least part of the plane.

A Gaussian profile also enables relatively easy fabrication of the laser while enabling good performances.

According to one particular characteristic, the laser is remarkable in that the standard deviation of the Gaussian variation of the loss profile in a central zone is between 1 and 5 μm.

The bias current range enabling operation in single-mode is relatively wide when the central zone (in other words close to the laser axis) is optimised when the standard deviation of the Gaussian profile is close to 2 μm.

According to one particular characteristic, the laser is remarkable in that the variation of the loss profile in the plane is axially symmetric.

According to one particular characteristic, the laser is remarkable in that at least one of the optical elements comprises droplets of a first composition dispersed in a product with a second composition, the diameter of the droplets being variable in the plane.

According to one particular characteristic, the laser is remarkable in that at least one of the optical elements comprises a nano-PDLC type material.

Thus, it is relatively easy to manufacture this laser, and good performances can be obtained (operating range in single-mode, emission power, etc.) as a function of the loss profile obtained by varying the size of Polymer Dispersed Liquid Crystal (PDLC) droplets).

According to one particular characteristic, the laser is remarkable in that it comprises means of applying an electric field to tune a wavelength associated with the laser.

Thus, the laser can operate in single-mode while being tuneable.

According to one particular characteristic, the laser is remarkable in that it forms a laser source type laser.

According to one particular characteristic, the laser is remarkable in that it comprises the following in sequence:
a first end adapted to enable emission of a laser beam;
a first mirror;
the cavity comprising the optical element(s);
a first electrode connected to a first electrical potential;
an active zone with multiple quantum wells;
a second mirror; and
a second electrode connected to a second electrical potential.

Thus, the laser is particularly simple to make and is relatively compact.

According to one particular characteristic, the laser is remarkable in that the second mirror is of the semiconductor Bragg type mirror.

Thus, the laser is even easier to make.

According to one particular characteristic, the laser is remarkable in that it comprises a third electrode adjacent to the first mirror and connected to at least one third electrical potential.

Thus, the laser is tuneable as a function of the third electrical potential, while remaining relatively simple to make.

The invention also relates to a high speed telecommunication system, remarkable in that it comprises at least one laser like that illustrated above and cooperating with at least one optical fibre for emission of at least one light beam emitted by the laser.

The invention also relates to a manufacturing method for a vertical cavity surface emitting laser (VCSEL), remarkable in that it comprises:
a step in which part of the laser is made, comprising at least one optical element; and
a step for insolation of the optical element according to an insolation profile that varies in a plane perpendicular to a propagation axis of at least one light beam in the laser.

According to one particular characteristic, the method is remarkable in that at least two zones are distinguished in the plane, the insolation profile being approximately constant in at least one of the zones and different in two of the distinct zones.

According to one particular characteristic, the method is remarkable in that the insolation profile varies approximately continuously in at least one part of the plane.

According to one particular characteristic, the method is remarkable in that the insolation profile varies in an approximately Gaussian manner in at least one part of the plane.

According to one particular characteristic, the method is remarkable in that the variation of the insolation profile in the plane is axially symmetric.

According to one particular characteristic, the method is remarkable in that the insolation step uses:
at least one light source producing an insolation beam; and
at least one filter adapted to make the insolation beam vary according to the insolation profile.

The advantages of the communication system and the manufacturing method are the same as the advantages for the laser, therefore they will not be described in more detail.

Other characteristics and advantages of the invention will become clearer after reading the following description of a preferred embodiment, given as a simple illustrative and non-limitative example, and the appended drawings among which:

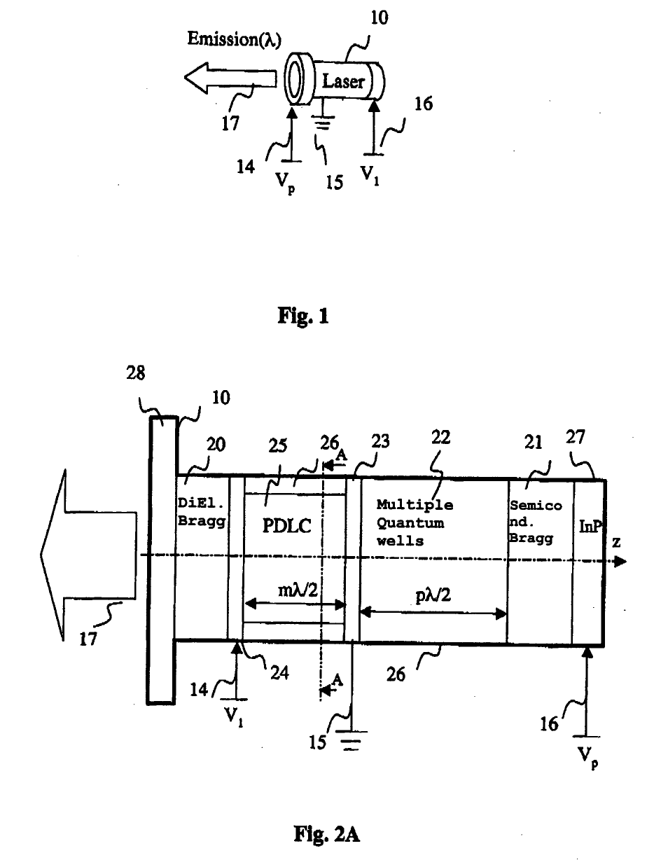

FIG. 1 shows a general perspective view of a laser conforming to the invention according to a particular embodiment;

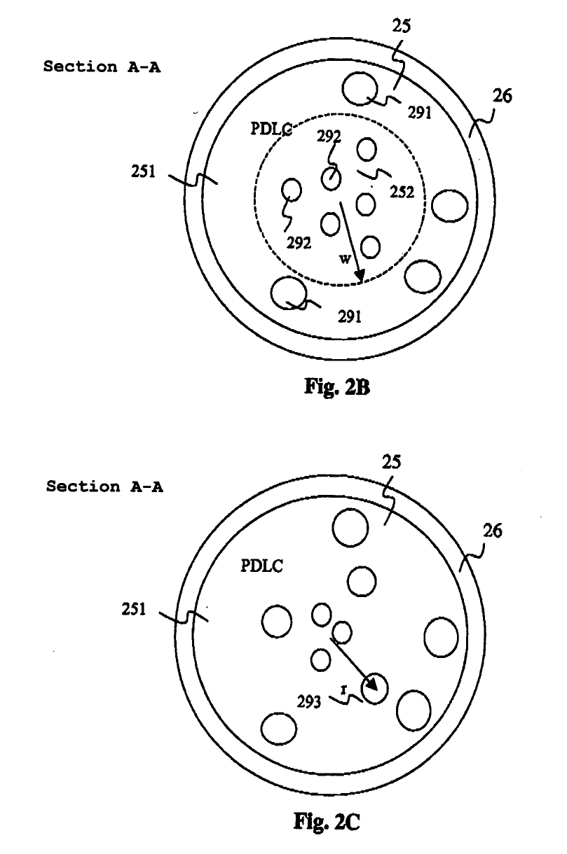

FIGS. 2A to 2C illustrate a principle diagram of the laser in FIG. 1;

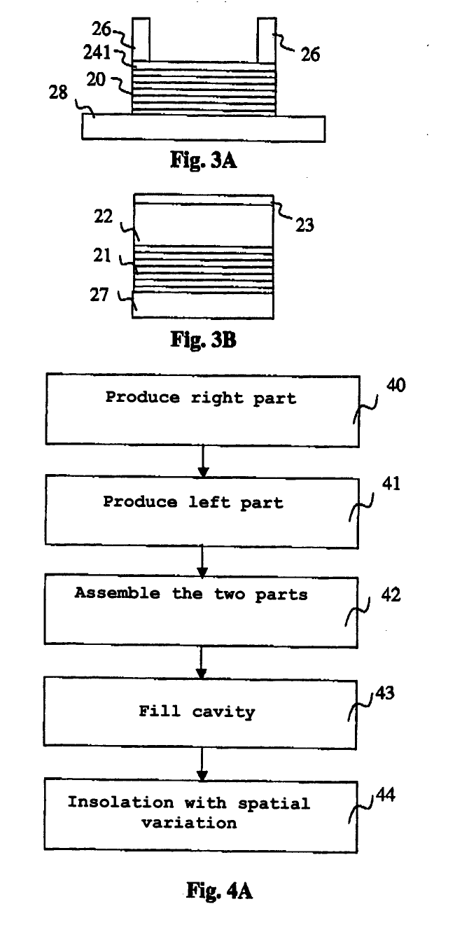

FIGS. 3A and 3B describe part of the laser in FIGS. 1 and 2 more precisely;

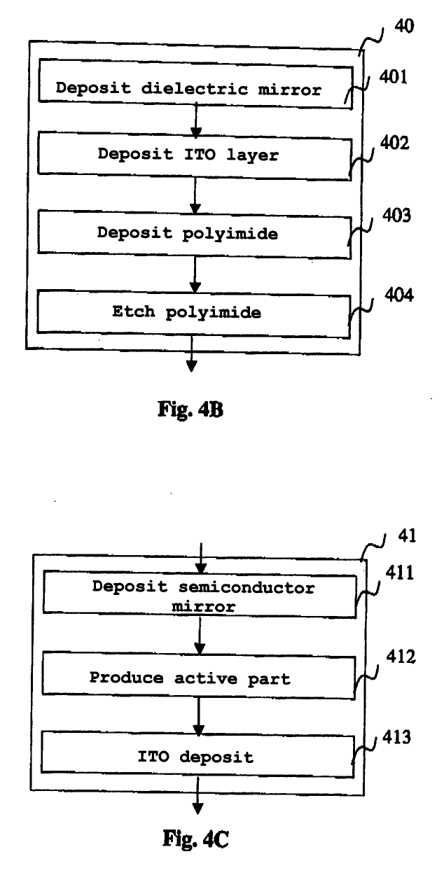

FIGS. 4A, 4B and 4C present a manufacturing method for the laser in the previous figures;

FIG. 5 illustrates the optical power emitted as a function of the bias intensity for a laser known in itself;

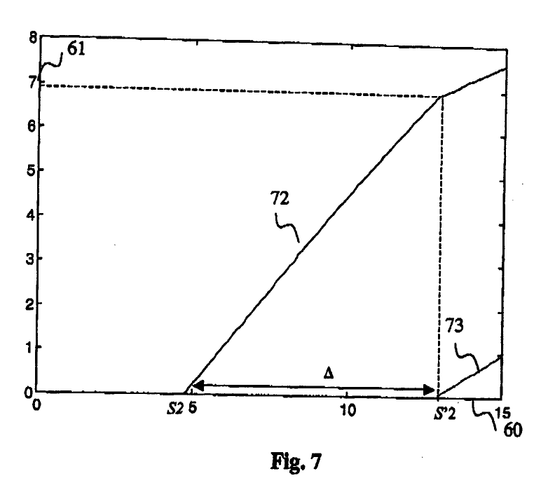

FIGS. 6 and 7 present the optical power emitted as a function of the bias intensity for a laser illustrated in FIGS. 1 and 2;

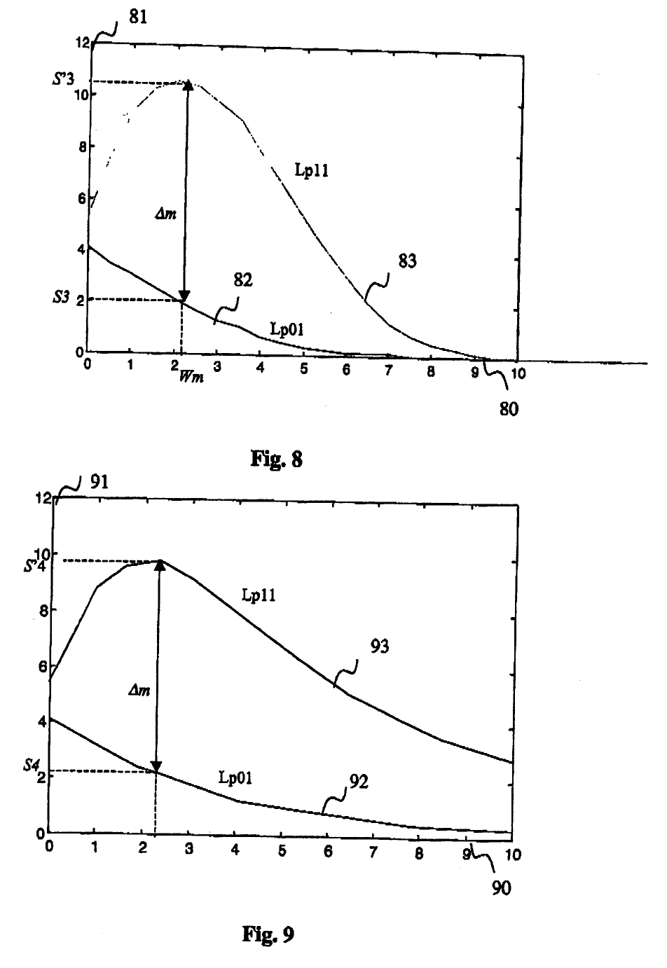

FIGS. 8 and 9 illustrate threshold currents as a function of the bias intensity for a laser illustrated with reference to FIGS. 1 and 2A;

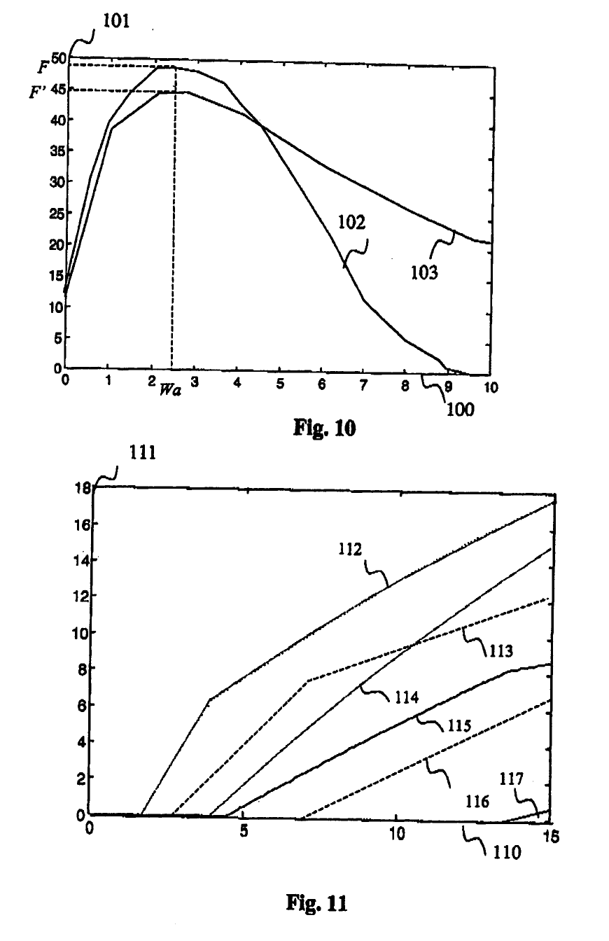

FIG. 10 shows an example of changes to the emission frequency as a function of the profile radius of a laser according to FIGS. 1 and 2A; and

FIG. 11 presents an optical emission power as a function of a bias intensity for tuneable lasers according to the invention.

1. General Principle of the Invention

The general principle of the invention is based on a VCSEL laser comprising a variable transverse loss profile (with or without discontinuity of loss coefficients), the variations in the loss profile being determined such that the difference between bias intensities at the threshold enabling emissions according to fundamental transverse mode and the first transverse mode is large. Thus, the bias intensity range between the two thresholds to force the VCSEL to operate in transverse single-mode is relatively large. Therefore, this profile provides a means of giving priority to either fundamental transverse mode or another mode in a flexible and easy-to-implement manner.

Moreover, the layer located in the cavity of the VCSEL may be a zone with a variable phase in order to tune the laser emission wavelength.

The invention also relates to the corresponding manufacturing method for a VCSEL laser, this method comprising insolation with spatial variation of a layer located in the laser cavity, this variation being configured so as to give priority to one of the transverse modes.

2. Producing a Laser According to the Invention

We will give a schematic presentation of a preferred embodiment of a tuneable VCSEL laser 10 with reference to FIG. 1 (not to scale).

Note that different electrical potentials are applied to the laser 10:
an electric pumping potential Vp of the laser 10 is connected to a point 16;
a potential V₁ is applied to a point 14, to tune the wavelength of the laser 10 as a function of the value of V₁; and
a zero potential is applied to a point 15.

The laser 10 is tuned to emit an optical beam 17 with a wavelength λ along a propagation axis z, the laser 10 preferably having approximately axial symmetry about this axis. This beam may be emitted in free space or directed to one or several optical fibres associated with the laser 10.

According to one variant not shown, the laser is optically pumped. The laser is then not connected to the potential Vp but is powered by an optical beam.

According to another variant of the invention used particularly to create a matrix of lasers to form a component emitting in distinct wavelengths or several separate components, several potentials V1, V2, . . . , Vn, are applied to the point 14, each of these potentials being connected to an ITO electrode etched on a substrate (for example made of transparent glass) perpendicular to the axis of the laser 10 and corresponding to a particular emission wavelength. If a component comprising several electrodes emits at several distinct wavelengths, the output beams may then in particular be transmitted to different optical fibres. In particular, all electrodes on the substrate may form paving of the substrate so as to optimise the number of electrodes as a function of the surface area of the substrate; thus according to the invention, a substrate can be made in which nine electrodes are printed uniformly distributed in a matrix of three rows each comprising three electrodes.

FIG. 2A diagrammatically illustrates the principle of the laser as illustrated with reference to FIG. 1, in the form of a longitudinal section.

The laser comprises a cavity closed by two DBR type mirrors:
a 21 to 45-pair semiconductor dielectric in which the elements have indexes 3.41 and 3.16 at a wavelength equal to 1.45 μm, in 1.45 μm quaternary (denoted Q1.45) and TnP respectively, the dielectric being adjacent to a transparent InP substrate 27 (since a semiconductor Bragg is easier to make than a dielectric Bragg, the active zone being cross-hatched, the Bragg itself and the substrate possibly being manufactured in a single step corresponding to successive and repeated depositions of a layer of InP and 1.45 μm quaternary); and
a DBR type of dielectric Bragg mirror 20 made of SiO₂ and TiO₂ with 8.5 pairs with indexes equal to 1.46 and 2.23 to 1.55 μm respectively adjacent to a transparent substrate 28.

Mirrors 20 and 21 are perpendicular to the longitudinal emission axis z of the light beam (in other words they are in a transverse plane).

The laser 10 is electrically pumped by the substrate 27 to which the potential Vp is connected. The substrate 28 enables collection of the laser emission through appropriate optical means (for example coupling micro-lenses).

Thus, the Bragg mirrors 20 and 21 are designed to be:
highly reflective at 1.55 μm (99.8% reflectivity for the Bragg mirror 20 and 99.7% for the mirror 21); and
transparent at 980 nm (reflectivity is less than 15%).

The cavity itself comprises the following elements in sequence:
an active zone 22 with three multiple quantum wells with seven wells made of InGaAs (Indium Gallium Arsenic) in barriers (1.18 μm quaternary denoted Q1.18), the zone 22 being adjacent to the Bragg mirror 21 and wells being placed on the maxima of the intra-cavity stationary field when the laser emits at 1.15 μm (a periodic gain is made);
a first electrode 23 is connected to the zero electrical potential 15;
a variable phase zone 25 containing a nano-PDLC type liquid crystal, the zone 25 being closed on the sides by a polyimide layer 26; and
an ITO type electrode 24 perpendicular to the z axis connected to the potential V₁ adjacent to the mirror 21.

The active zone 22 has an index of about 3.3 and a length of the order of 700 nm. The variable phase zone 25 has an index of about 1.55 and a length of about 6 μm, corresponding to an optical thickness equal to 6λ.

The electrodes 14 and 15 are sufficiently thin (a few tens of nanometres) to be considered as being transparent).

Application of a variable electrical field E created by the potential difference between the electrodes 23 and 24 and applied parallel to the direction of propagation of the emission (along the z axis of laser 10) at zone 25 with variable phase provides a means of tuning the resonant wavelength of the cavity. Thus, a variation in the laser wavelength equal to 20 nm can be obtained around 1.55 μm for a potential V₁ equal to 100 Volts.

The weakness of the reflection at the semiconductor/nano-PDLC interface provides a means of eliminating the use of an anti-reflection treatment that would complicate the structure and would reduce the longitudinal overlap factor for the same cavity and phase shift zone length.

However, the use of an anti-reflection treatment may be necessary for some embodiments.

The choice of the relative thicknesses of the two elements forming the cavity depends on a compromise between:
a reasonable value of the active thickness (in other words sufficiently thick) to obtain a reasonable overlap factor and therefore a conventional laser threshold; and
the largest possible phase shift zone to obtain the largest possible tuneability range.

The total thickness is chosen to be thin enough to obtain an ISL compatible with tuneability (in other words ISL greater than the tuneability band) without mode skip and with possible nano-PDLC bias voltages. The ISL is inversely proportional to the length of the cavity. Therefore, the ISL is large enough if the cavity is short enough.

The following parameters characterise the laser 10:
index of the glass (substrate): 1.5;
index of the quaternary Q1.18: 3.33;
index of the InGaAs (quantum well): 3.56;
index no of the nano-PDLC: 1.513; and
applied tuneability field V₁: 30V/μm.

A liquid crystal formed from droplets dispersed in a polymer medium, for example of the Polymer Dispersed Liquid Crystal (PDLC) type, for which the size varies as a function of the insolation power applied during manufacture of the laser may behave differently depending on the size of the droplets compared with the usage wavelength (1.55 μm):
for droplets with a diameter of between 10 and 100 nm, the material behaves like a variable phase shifter; while
for droplets with a diameter of between 500 and 1000 nm, the material behaves like a random diffuser and attenuates light.

The transition between these two phases is made continuously and intermediate behaviours are observed in which both phase shift and attenuation are present. According to the invention, this property is used by insolating the material included within the zone 25 differently when manufacturing the laser 10.

Thus, the diameter of nano-PDLC droplets included in the cavity 25 varies in a plane perpendicular to the z axis of the laser 10 (transverse plane). FIG. 2B shows a section AA of the zone 25 of laser 10 as illustrated with respect to FIG. 2A and diagrammatically shows the diameter of the nano-PDLC droplets (the drawing is not to scale).

Thus, according to one embodiment of the laser 10 called the binary loss profile, the zone 25 is divided into two distinct concentric zones 251 and 252 with diameters of 100 μm and 4 μm respectively, the binary profile having a discontinuity in the droplet size between the two zones. The first central zone 251 with radius w equal to 2 μm comprises droplets 292 with a diameter close to 100 nm smaller than the diameter of the droplets 291 contained in the second zone 252 that is close to 500 nm (the second zone 252 itself having a diameter close to 100 μm very much larger than the diameter of the first zone 251). A loss coefficient α is defined as being the optical power loss coefficient in a material. If P₀ is the incident power and P₁ is the power transmitted by the material and l is the material length, P₀ and P₁ respect the relation P₁=P₀e^{-α1}. According to the embodiment described herein, the loss coefficient α_{npdlc} is equal to 13 cm⁻¹ in zone 251 and is equal to 50 cm⁻¹ in zone 252.

According to one variant of this embodiment, the laser has a discontinuous profile with several zones: zone 25 is divided into at least two zones (for example two, three, four or more) with arbitrary shapes that are not necessarily cylindrical (for example parallelepiped-shaped) or concentric, each of the zones containing droplets with a size approximately equal to each other and the droplet size varying from one zone to another, the size of the different zones and the differences in sizes of the droplets in two different zones being sufficient to enable operation of the laser 10 in single-mode throughout a wide bias current range.

According to another embodiment of the so-called “continuous profile” laser 10 illustrated with reference to FIG. 2C, the zone 25 contains crystal droplets with a size that varies continuously between different regions of the zone 25, this variation being made in a transverse plane of laser 10. Thus, for example, the size of the droplets can vary according to a Gaussian profile with standard deviation σ equal to 2 μm as a function of the distance r of the droplets from the laser 10 axis, between a minimum value equal to approximately 100 μm at the centre and a maximum value close to 500 μm in the external part adjacent to layer 26. In this case, the loss coefficient α_{npdlc} in zone 25 as a function of the distance r respects the following relation:
α_{npdlc}(r)=13+(50−13)(1e^{-r2/w2})=13+37(1−e^{-r2/w2})

According to one variant of the invention, the size of the droplets varies continuously according to an arbitrary law that gives priority to a transverse mode of the laser at the detriment of the other modes, for example according to a Lorentzian profile associated with a loss coefficient α_{npdlc} as a function of the distance r that respects the following relation (inverse Lorentzian with width at mid-height equal to 4 μm):

$${α}_{npdlc} ( r ) = 50 - \frac{148}{{r}^{2} + 4}$$

where the distance r is expressed in μm.

In general, the dimension of the liquid crystal droplets can be adjusted in space at the time of insolation so that a spatial filter with a complex amplitude can be implemented and therefore the insolation can be configured according to the different variation profiles in the required droplet size.

According to one variant of the invention illustrated with reference to FIG. 1, different potentials V1, V2, . . . , Vn are applied to the point 14 and the electrode 24 is replaced by a set of n electrodes connected to a non-zero potential V₁, V₂, . . . , Vₙ respectively. According to one particular embodiment of this variant, the zone 25 contains cylindrical or parallelepiped-shaped nano-PDLC strips parallel to the z axis and located inside the zone 25 between electrodes at voltages V₁, V₂, . . . , and Vₙ, each of the nano-PDLC zones associated with these electrodes being subjected to a quasi-constant field equal to E₁, E₂, . . . , Eₙ respectively. Thus, each of these nano-PDLC zones has its own index n₁, n₂ and nₙ, respectively, so that wavelengths λ₁, λ₂ . . . and λₙ can be tuned independently with a single component with a wide operating range in single-mode and/or its own nano-PDLC droplet size profile (the size of droplets only making the index varying slightly compared with the voltages V₁, V₂, . . . , and Vₙ). Thus, it is possible to emit a beam to each fibre associated with the component, the beam having a single precise wavelength (operation in single-mode) tuned as a function of the potential Vᵢ applied to the corresponding electrode, independently of the other beams and/or to make “wafers” of components that can be separated and used independently.

3. Production of the Different Parts of the Component

FIG. 3A more precisely describes the end containing the cavity 25 of the laser 10 filled with nano-PDLC through which the light beam is emitted and FIG. 4B shows its manufacturing method.

This end of the component (left part in FIG. 2A) is manufactured 40 in several steps.

During a first step 401, the dielectric Bragg mirror is deposited on an optical quality glass plate 28 by vacuum deposition.

Then during a step 402, a thin ITO layer making up the first electrode is then deposited, to enable bias of the nano-PDLC layer.

According to a variant described above that makes it possible to independently tune several beams in the same laser, the ITO layer is etched to make circular electrodes (replacing the electrode 24) that can be polarised independently. Thus, a matrix of independent components or a component emitting in several wavelengths can be made.

Then during a step 403, a sacrificial layer 26 of polyimide is deposited with a spinner, to a thickness controlled to within 2%.

Then during a step 404, this layer is attacked by selective etching so as to leave pads that are then used to bring this part into contact with the second part of laser 10 by leaving a space with a thickness controlled to within 2% in the cavity that could be filled with nano-PDLC.

FIG. 3B more precisely describes the opposite end of the laser 10 and FIG. 4C shows the method used to manufacture it.

The end comprising zone 22 comprising the semiconductor Bragg 21 (right part in FIG. 2A) is produced 41 in several steps.

During a first step 411, the semiconductor Bragg is made by vacuum and successive deposition of pairs (epitaxy) on an InP substrate 27.

Then during a step 412, the active part 22 of the component is grown by epitaxy.

Then during a step 413, a thin layer of ITO is deposited forming the electrode 23 connected to the ground.

FIG. 4A describes production of the laser 10 more globally.

The two parts of the component are made as illustrated with reference to FIGS. 4B and 4C during the first two steps 40 and 41.

The two parts of the component thus made are then brought into contact in step 42.

Then during a step 43, the cavity formed by assembly of the two parts is filled with nano-PDLC in the form of a liquid crystal and liquid polymer mix.

Then during step 44, the nano-PDLC is insolated with spatial variation so that the polymer is polymerised thus forming liquid crystal droplets in the solidified matrix of polymers that glues the two parts of the laser.

The manufacturing method for the variable phase zone requires UV (ultraviolet) insolation of the liquid crystal/polymer mix placed in the cavity 25 through the dielectric Bragg mirror 20. The UV power denoted P_{UV} used controls the size of the liquid crystal droplets dispersed in the polymer matrix and therefore the value of the loss coefficient associated with diffusion in the phase zone. According to the invention, this layer is selectively insolated using an adapted mask (or a UV filter) so as to obtain, for example:
a small value of the loss coefficient α_{npdlc} equal to 13 cm⁻¹ for an insolation power P_{UV} equal to 350 mW/cm² (by definition, the loss coefficient α is the coefficient of loss of optical power in a material. If P₀ is the incident power and P₁ is the power transmitted by the material and 1 is the material length, P₀ and P₁ respect the relation P₁=P₀e^{-α1}) on a cylinder a few microns in diameter and capable of obtaining the zone 252 illustrated with reference to FIG. 2B; and
a larger value of the loss coefficient α_{npdlc} equal to 50 cm⁻¹ for an insolation power P_{UV} equal to 300 mW/cm² around this cylinder to obtain the zone 251 illustrated with reference to FIG. 2B.

Thus, the result is a laser with a binary losses profile comprising two zones 251 and 252 with axial symmetry (nested cylinders along the same axis) with different optical loss coefficients.

This results in a low value of the average modal loss coefficient of the cavity for mode LP01 and a high value for the coefficient for mode LP11, without any major modification of the phase shift that determines the tuneability range.

Using this type of transverse losses profile that gives priority to the fundamental mode, the laser remains transverse single-mode over a wide range of the bias current. The transverse variation in the size of the droplets does not cause any transverse variation in the index with zero field, and also the maximum value of the index variation is the same in zones 251 and 252.

Saturation of the index variation will be reached for higher fields at the centre which modifies mode guidance conditions. However, this effect is negligible for the small difference in insolation power indicated and necessary for modal selection. In other words, differences in index are neglected in zones 251 and 252, regardless of the applied field.

4. Optimisation of the Insolation Profile

FIGS. 6 to 9 illustrate different behaviours of the laser 10 according to the invention particularly as a function of the bias intensity, the type of insolation profile (binary or continuous, of the Gaussian type causing a losses profile corresponding to the laser component) and the radius of the insolation profile.

More precisely, FIGS. 6 and 7 illustrate the optical power 61 of the laser 10 emitted in modes LP01 and LP11 as a function of the bias current 60 for the following, respectively:
a binary insolation profile for obtaining a cavity for which a section is illustrated with reference to FIG. 2B; and
a Gaussian insolation profile for obtaining a cavity for which a section is illustrated with reference to FIG. 2C.

FIG. 6 shows a curve 62 more precisely illustrating the variation of the power emitted in the fundamental transverse mode LP01, while curve 63 corresponds to the power transmitted in the second mode associated with the first transverse mode LP11. FIG. 7 shows a curve 72 more precisely illustrating the variation of the power emitted in the fundamental transverse mode LP01, while curve 73 corresponds to the power transmitted in the second mode associated with the first transverse mode LP11. Threshold S1 of mode LP01 is approximately 4.2 mA while threshold S′1 is approximately 13.7 mA, and threshold S2 of mode LP01 is approximately 4.7 mA while threshold S′2 is approximately 13.7 mA. Thus, the VCSEL is single-mode for a bias intensity between 4.4 mA and 13.7 mA for threshold S′1 or between 4.7 mA and 12.8 mA for threshold S′2 and 12.8 μm for S′2, and is multimode when it exceeds 13.7 mA for S′1 and 12.8 μm for S′2. It is observed that the difference A between thresholds S1 and S′1 is of the order of 9.5 mA, and the difference Δ between thresholds S2 and S′2 is of the order of 8.1 mA, these values being considerably higher than the difference illustrated in FIG. 5 corresponding to the same structure without a variable transverse profile (in other words with a uniform loss profile equal to 13 cm⁻¹ in a transverse nano-PDLC plane). Thus, according to the invention, it is relatively easy to obtain operation in single-mode with this type of VCSEL. Furthermore, in single-mode operation, the optical power can be as high as about 8.2 with binary insolation and 6.8 with Gaussian insolation that can be compared with 2 for a uniform loss profile as illustrated with reference to FIG. 5 (the power scales being the same in the different figures). Thus, the optical power available in single-mode emission is also increased.

FIGS. 8 and 9 illustrate the variation of the relative threshold currents (difference between the mode threshold current for a profile with radius w and the threshold current for the same mode without transverse profile (for the fundamental transverse mode LP01 and the first transverse mode LP11 as a function of the radius w associated with a binary insolation (curve 82 for LP01 and curve 83 for LP11) and a Gaussian insolation (curve 92 for LP01 and curve 93 for LP11) corresponding to a laser similar to the laser illustrated with reference to FIGS. 2B for LP01 and 2C for LP11.

For the two profiles (Binary and Gaussian), the relative threshold of mode LP01 tends towards zero when the radius increases (in other words when approaching the case with no profile). On the other hand, the relative threshold corresponding to mode LP11 increases for low radii, goes through an optimum and then decreases towards 0. The difference A between the thresholds corresponding to LP01 and LP11 is practically a maximum when the relative threshold corresponding to the first transverse mode is maximum and is obtained for a value of w close to 2 μm in the two profile types (Binary and Gaussian).

For the optimum, the bias current range that can be achieved in single-mode operation in the case of the binary profile (of the order of 9.5 mA), is larger than in the case of the Gaussian profile (maximum range of the order of 8.1 mA). For the Gaussian profile, thresholds tend towards their value without profile (case in which losses in a transverse plane are constant) more slowly as a function of the radius due to the infinite decay of the Gaussian curve.

5. Dynamics of the Laser with a Zero Tuneability Field

The resonant frequency of the laser 10 is given by the following equation:

$${f}_{r} = \frac{1}{2 π} \sqrt{{η}_{i} \frac{Γ {v}_{g} {\partial }_{g}}{qV \partial N}} ( I - {I}_{s} )$$

where:
   ηᵢ is the internal quantum efficiency of the VCSEL 10;
Γ is the confinement factor;
v_{g} is the velocity of the group in the cavity material;
q is the electron charge;
V is the volume of the cavity 25;
is the differential gain;
I is the bias current; and

Iₛ is the bias current at the threshold.

The pass band of the VCSEL is given by the relation:
f_{3db}≈1.55 fᵣ, if parasite effects are not too important.

FIG. 10 shows the variation of the relative resonant frequency 101 (defined as being the difference between the resonant frequency (which is similar to the maximum frequency at which the laser 10 can be directly modulated) of the laser with a profile with radius w and the resonant frequency of the same laser without a variable loss profile (w tending towards infinity, giving a frequency of the order of 18.5 GHz) as a function 100 of the radius w of the profile for the binary case (curve 102) or the Gaussian case (curve 103). This frequency is calculated for the bias current corresponding to the threshold of mode LP11 (single-mode operating limit of laser 10).

The resonant frequency of the VCSEL 10 is considerably increased due to the presence of a transverse losses profile. The resonant frequency is maximum for a radius wa of approximately 2.5 μm in the binary case (maximum frequency F equal to 67.6 GHz) and in the Gaussian case (maximum frequency F′ equal to 63.5 GHz) and then decreases towards the value of the case without transverse profile (18.5 GHz). The binary profile gives better performances by enabling a higher maximum resonant frequency than with a Gaussian profile and therefore a better pass band of the VCSEL 10.

6. Effect of Application of a Field to Tune the Laser

FIG. 11 illustrates the variation of the transmitted optical power 111 as a function of the bias intensity 110, this power being obtained by simulation for different values of the voltage V1 applied to the variable phase zone 25 and is used to tune the resonant wavelength of the laser 10:
the corresponding curves 112 and 114 correspond to a value of V1 equal to 100 V for the transverse fundamental mode LP01 and the first order transverse mode LP11 respectively;
the corresponding curves 113 and 116 correspond to a value of V1 equal to 50 V for modes LP01 and LP11 respectively; and
the corresponding curves 115 and 117 correspond to a zero value of V1 for modes LP01 and LP11 respectively.

The three simulated voltages equal to 0V, 50V and 100V respectively cover the entire tuneability range of the laser 10.

The variation with the applied field associated with the voltage of the nano-PDLC losses coefficient over the entire transverse profile was taken into account.

The simulated profile is a binary profile with a radius w equal to 2 μm.

When the voltage V₁ increases, the reduction of losses in the nano-PDLC layer reduces the thresholds of modes LP01 and LP11. In practice, the loss coefficient α reduces slightly when the voltage V1 changes from 0 to 10 V, decreases almost linearly and more steeply when the voltage V1 varies from 10 to 80 V and remains approximately constant when V1 exceeds a value equal to approximately 80 V (in which case saturation takes place).

Moreover, in single-mode operation, the bias current window (or the difference Δ between bias thresholds) reduces if the voltage V₁ increases, since the difference between modal losses associated with near and far parts of the laser axis reduces.

On the other hand, the laser emission power increases when the voltage V1 increases because optical losses in the nano-PDLC reduce.

A compromise between the emission power and the width of the operating range in single-mode giving priority to one of these two aspects may be found with a great deal of flexibility by making an appropriate choice for the voltage V1 between 0 and about 100 V.

If laser tuneability is required while keeping a wide single-mode operating range and a relatively high emission power, the laser is preferably defined by putting it at a voltage V1 equal to approximately 50 V and V1 is varied around this value to tune the laser thus obtained.

Obviously, the invention is not limited to the example embodiments mentioned above.

According to the invention, introducing a transverse losses profile into the cavity of a VCSEL can considerably increase the bias current range in single-mode operation, and its pass band.

In particular, those skilled in the art could make any variation to the nature of the profiles of the optical elements, that is not limited to the binary profile or Gaussian profile but which may include:
several zones corresponding to different droplet sizes in a plane perpendicular to the optical propagation direction of the laser; or
one or several zones in which the droplet size varies approximately continuously.

The binary profile with a radius of 2 μm provides better laser performances than a Gaussian profile. An intermediate profile between binary and Gaussian may be used to make the binary profile more uniform in the droplet formation dynamics.

Furthermore, those skilled in the art would also be able to change the variation of the droplet size in the case of a continuous variation, or in the differences between droplet sizes when there are several zones, each corresponding to one droplet size.

The manufacturing method is not limited to the case in which insolation is applied with a lamp emitting a constant spatial power, light then being filtered by an adapted filter that more or less strongly filters light as a function of the required droplet diameter in a corresponding zone, and also includes any insolation that can obtain droplets with a spatially variable size. In particular, a laser can be made according to the invention by scanning the surface of a crystal—polymer mix with a very fine ultraviolet laser source with adjustable power.

According to the invention, the inside of the cavity may also contain a non-active optical element, for example a semiconductor (in addition to or instead of an active optical element such as nano-PDLC) for which the absorption spectrum is locally offset by applying an electric field making use of the Franz Keldysh effect. Thus, in the cavity containing the inactive optical element, transverse profiles with variable loss coefficients are defined by applying an electric field that is variable in a transverse plane.

In particular, a binary profile can be defined in which two zones are identified (similar to the embodiment described above with reference to FIG. 2B) as a function of an electric field applied on each of its zones:
a first central cylindrical zone with a radius equal to 2 μm placed on the laser axis; and
a second zone surrounding the first zone with inside radius equal to 2 μm and outside radius equal to approximately 50 μm.

In this case, an electric field E2 is applied parallel to the axis of the laser (generated by a potential difference between an electrode connected to the ground and an electrode to which a voltage V2 is applied), the electrodes being placed perpendicular to the axis of the laser at each end of the first zone. Similarly, an electric field E3 is applied parallel to the axis of the laser (generated by a potential difference between an electrode connected to the ground and an electrode to which a voltage V3 is applied), the electrodes being placed perpendicular to the axis of the laser at each end of the second zone. If the voltage V2 is zero or close to 0 V and if the voltage V3 is sufficiently high to create a loss coefficient on the second zone (where V3 is for example greater than 100 V), the first transverse mode will be affected by losses on the second zone, on the other hand the fundamental mode being given priority, so that emission in single-mode is possible according to the fundamental mode over a wide range of bias thresholds. On the other hand, if the voltage V3 is equal to or is close to 0 V and if the voltage V2 is sufficient to create a loss coefficient on the first zone (where V2 for example is greater than 100 V), priority will be given to the first transverse mode at the detriment of the transverse fundamental mode, which will enable emission in single-mode along a first transverse mode over a wide bias threshold range.

Obviously, with this operation the laser can also be tuned; for example, a voltage V2 close to or equal to zero and a voltage V3 varying around approximately 50 V can be applied to tune the wavelength of the laser in single-mode mode giving priority to the transverse fundamental mode. Similarly, a voltage V3 close to or equal to zero and a voltage V2 varying around approximately 50 V can be applied to tune the wavelength of the laser in single-mode mode giving priority to the transverse first mode.

The invention is used in applications in telecommunications (particularly in low or high speed data transmission, data transmission on multimode fibres, etc.), but also in many other domains using laser beams (particularly in medicine).

The invention is not limited to the case in which the laser gives priority to fundamental transverse mode, but also relates to the case in which the first transverse mode or another transverse modes is given priority to the detriment of the fundamental mode. In this case, the crystal droplets are larger at the centre than at the outside and the bias threshold corresponding to the first transverse mode becomes smaller than the bias threshold associated with the fundamental transverse mode. Thus, a donut-shaped beam can be obtained (a disk with a hole in the middle) that can be suitable for some applications (for example in medicine).

In particular, the laser according to the invention can be used as a laser source, amplifier, switch and/or optical gate.

Moreover, application of a voltage to the phase zone to vary the resonant wavelength reduces the range in single-mode operation.

1. Vertical cavity surface emitting laser (VCSEL) (10) comprising at least one optical element inside the said cavity (25), wherein the said at least one optical element has a variable phase and a variable optical loss profile in a plane perpendicular to an axis of propagation of at least one light beam (17) passing through the said cavity so as to encourage transverse mode of the said laser.

2. Laser according to claim 1, wherein the said transverse mode is the fundamental transverse mode.

3. Laser according to claim 1, wherein the said transverse mode is the first transverse mode.

4. Laser according to claim 1, wherein at least two zones (251, 252) are distinguished in the said plane, the said loss profile being approximately constant in at least one of the said zones and different in two distinct zones.

5. Laser according to claim 4, wherein the radius of a central zone among the said zones is between 1 and 5 μm.

6. Laser according to claim 1, wherein the said loss profile varies approximately continuously in at least part of the said plane.

7. Laser according to claim 6, wherein the said loss profile varies in an approximately Gaussian manner in at least part of the said plane.

8. Laser according to claim 7, wherein the standard deviation of the Gaussian variation of the said loss profile in a central zone is between 1 and 5 μm.

9. Laser according to claim 1, wherein the variation of the said loss profile in the said plane is axially symmetric.

10. Laser according to claim 1, wherein at least one of the optical elements comprises droplets (291, 292, 293) of a first composition dispersed in a product with a second composition, the diameter of the said droplets being variable in the said plane.

11. Laser according to claim 10, wherein at least one of the said optical elements comprises a nano-PDLC type material.

12. Laser according to claim 1, wherein it comprises means (14, 15, 23, 27) of applying an electric field to tune a wavelength associated with the said laser.

13. Laser according to claim 1, wherein it forms a laser source type laser.

14. Laser according to claim 1, wherein it comprises the following in sequence:
a first end (28) adapted to enable emission of a laser beam;
a first mirror (20);
the said cavity comprising the said at least one optical element;
a first electrode (23) connected to a first electrical potential;
an active zone (22) with multiple quantum wells;
a second mirror (21); and
a second electrode (27) connected to a second electrical potential.

15. Laser according to claim 14, wherein the said second mirror is a semiconductor Bragg type mirror.

16. Laser according to either claim 14, wherein it comprises a third electrode (24) adjacent to the said first mirror and connected to at least one third electrical potential.

17. High speed telecommunication system, wherein it comprises at least one laser according to claim 1, cooperating with at least one optical fibre for emission of at least one light beam emitted by the said laser.

18. Manufacturing method for a vertical cavity surface emitting laser (VCSEL), wherein it comprises:
a step in which at least one optical element with a variable phase is selected;
a step in which part of the said laser comprising the said optical element is made, and
a step (44) for insolation of the said optical element according to an insolation profile variable in a plane perpendicular to a propagation axis of at least one light beam in the said laser.

19. Method according to claim 18, wherein at least two zones are distinguished in the said plane, the said insolation profile being approximately constant in at least one of the said zones and different in two of the said distinct zones.

20. Method according to claim 18, wherein the said insolation profile varies approximately continuously in at least one part of the said plane.

21. Method according to claim 20, wherein the said insolation profile varies in an approximately Gaussian manner in at least one part of the said plane.

22. Method according to claim 18, wherein the variation of the said insolation profile in the said plane is axially symmetric.

23. Method according to claim 18, wherein the said insolation step uses:
at least one light source producing an insolation beam; and
at least one filter adapted to make the said insolation beam vary according to the said insolation profile.
